(19) United States
(12) Patent Application Publication
(10) Pub. No.: US 2016/0036674 A1
(43) Pub. Date: Feb. 4, 2016

(54) WIRELESS COMMUNICATION SYSYEM, CONTROL METHOD OF THE SYSTEM, WIRELESS COMMUNICATION TERMINAL AND WIRELESS COMMUNITATION BASE STATION

(71) Applicant: KYOCERA CORPORATION, Kyoto-shi, Kyoto (JP)

(72) Inventor: Kazuha TANAKA, Yokohama-shi (JP)

(73) Assignee: KYOCERA CORPORATION, Kyoto (JP)

(21) Appl. No.: 14/775,398

(22) PCT Filed: Mar. 12, 2014
(86) PCT No.: PCT/JP2014/001408

§ 371 Date: Sep. 11, 2015

(30) Foreign Application Priority Data
Mar. 13, 2013 (JP) 2013-050820

(51) Int. Cl. H04L 12/26; H04W 24/08; H04W 76/06

(52) U.S. Cl. CPC H04L 43/0847; H04W 76/06; H04W 24/08

(57) ABSTRACT

A wireless communication terminal (1) has a first counter (12) that counts the number of downlink consecutive reception error frames relating to a wireless signal channel and a first controller (15) that determines whether or not to disconnect the channel based on the number of downlink consecutive reception error frames counted by the first counter (12) and a communication quality relating to the channel. A wireless communication base station (2) has a second counter (22) that counts the number of uplink consecutive reception error frames relating to the channel and a second controller (25) that determines whether or not to disconnect the channel based on the number of uplink consecutive reception error frames counted by the second counter (22) and the communication quality relating to the channel.

### CROSS REFERENCE TO RELATED APPLICATION

This application claims priority of Japanese Patent Application No. 2013-050820 (filed on Mar. 13, 2013), the entire contents of which are incorporated herein by reference.

### TECHNICAL FIELD

This disclosure relates to a wireless communication system, a control method of the system, a wireless communication terminal and a wireless communication base station.

### BACKGROUND

A wireless data communication apparatus that performs wireless data communication over a plurality of lines by a multi-link system has been known, in the apparatus, a line is selected by switching a data path based on the monitoring information obtained from monitoring of the line state (see, for example, PTL 1). The apparatus disconnects a line in a poor state of communication quality, or the like, and transmits the data over another line.

### CITATION LIST

### Patent Literature

PTL 1: JP2000174770A

### SUMMARY

However, in order to maintain a wireless communication in a weak electric field such as a communication area boundary, or the like, a conventional channel (line) disconnect function, or the like, has occasionally suppressed smooth disconnection (switching) of a channel when a consecutive reception error occurs in the channel during communication in an intense electric field. This is described below with reference to the accompanying drawings.

FIG. 5 is a flowchart diagram illustrating an operation of a conventional wireless communication terminal. FIG. 5 illustrates an operation to one channel among a plurality of channels used for communicating with a wireless communication base station. First, a conventional wireless communication terminal waits for receiving a frame relating to downlink (downstream) communication (step S101), and next, determines whether the frame has been successfully received or not (step S102). When the terminal has successfully received the frame in step S102, it sets the number of consecutive reception error frames to zero (step S103) and the process returns to step S101. On the other hand, in step S102, when the terminal has failed to receive the frame, it increments the number of consecutive reception error frames (step S104). Then, the terminal determines whether or not the number of consecutive reception error frames is a predetermined value (e.g. 10 times or 5 ms per 1 frame) or more (step S105). When the number of consecutive reception error frames is 10 times or more in step S105, the channel is disconnected and the other unused channel is reconnected (step S106), then the process is terminated. On the other hand, when the number of consecutive reception error frames is less than 10 times in step S105, the process returns to step S101.

The operation of a conventional wireless communication terminal when consecutive reception error occurs in a weak electric field is described specifically with reference to FIGS. 6 and 7. FIG. 6 is a diagram illustrating a channel operation of a conventional wireless communication terminal when consecutive reception error occurs in a weak electric field. FIG. 7 is a diagram illustrating a channel reception state of a conventional wireless communication terminal when consecutive reception error occurs in a weak electric field. In FIGS. 6 and 7, the wireless communication terminal communicates with the wireless communication base station 2 using three channels (channels 1, 3 and 5). Furthermore, FIGS. 6 and 7 illustrate 16 frames in total from AFNs (Absolute Frame Number) 100 to 115.

First, in AFNs 100 and 101, the downlink reception quality relating to channel 3 is −106 dBm. Next, in AFNs 102 to 108, a reception error frame occurs 7 times in a row in channel 3, and during this, there is a decline in communication throughput since communication is made between two channels. Then, in AFNs 109 to 115, channel 3 repeats success in reception and failure in reception. In a weak electric field, even if a terminal disconnects a channel of declined quality and switches to an unused new channel, probability of reconnection is low. Thus, when success in reception and failure in reception are repeated, it is preferable to maintain a connection without disconnecting a channel. In a conventional wireless communication system, disconnection is not made unless the number of consecutive reception error frames reaches 10 times or more in each channel (line). Thus, the channel 3 is not disconnected and communication can be maintained.

In this manner, the conventional channel disconnect function in case of consecutive reception frame error works normally as a system for maintaining a minimum communication throughput in a weak electric field such as a communication area boundary, or the like.

However, such channel disconnect function has occasionally reduced the communication throughput in the state where a reception error frame occurs suddenly in a row in an intense electric field. That is, when a reception error frame occurs suddenly in a row in one channel due to interference, or the like, it is easy to disconnect the channel and reconnect with another channel of different frequency, in an intense electric field. However, with the conventional channel disconnect function, the threshold of the number of consecutive reception error frames until the channel is disconnected is fixed to 10 times. The channel is not disconnected unless a reception error occurs 10 times or more in a row, thus the communication throughput remains low for a long period of time (for 50 ms).

The operation of the conventional wireless communication terminal when consecutive reception error occurs in an intense electric field is described specifically with reference to FIGS. 8 and 9. FIG. 8 is a diagram illustrating a channel operation of a conventional wireless communication terminal when consecutive reception error occurs in an intense electric field. FIG. 9 is a diagram illustrating a channel reception state of the conventional wireless communication terminal when consecutive reception error occurs in an intense electric field. In FIGS. 8 and 9, the wireless communication terminal communicates with the wireless communication base station 2 using three channels (channels 1, 3 and 5). Furthermore, FIGS. 8 and 9 illustrate 16 frames in total from AFNs 100 to 115.

First, in AFNs 100 and 101, the downlink reception quality relating to the channel 3 is −69 dBm. Next, in AFNs 102 to 111, a reception error frame occurs 10 times in a row in the channel 3, and during this, communication is made between two channels, thus there is a decline in communication throughput. Here, in AFN 111, the number of consecutive reception error frames exceeds 10 times, thus the terminal disconnects the channel 3 and reconnects with the unused channel 7. Then, in AFNs 112 to 115, three channels (channels 1, 5 and 7) are used for communication, thus a communication throughput is maintained. Because of an intense electric field, reconnection with the channel 7 is performed easily.

Thus, in an intense electric field, despite easy connection with the channel 7, it should be waited to switch the channel until the number of consecutive reception error frames exceeds 10 times in the channel 3 and, during this a communication throughput is occasionally declined.

As a means for solving such problem, a predetermined value of the number of frames for determination of channel disconnection may be set lower. However, if the number of frames for determination of channel disconnection is unconditionally decreased, channel disconnection occurs more than necessary in a weak electric field such as a communication area boundary, or the like, leading to a decline in communication throughput.

This disclosure has been conceived in light of the above problem and it could be helpful to provide a wireless communication system, a control method of the system, a wireless communication terminal and a wireless communication base station capable of suppressing decline in a communication throughput depending on the wireless circumstances, whether it be a weak electric field or an intense electric field.

In order to solve the above problem, in the disclosed wireless communication system in which a wireless communication terminal and a wireless communication base station communicate with each other over one or more wireless signal channels, the wireless communication terminal has:
a first counter configured to count a number of downlink consecutive reception error frames relating to the channel; and
a first controller configured to determine whether or not to disconnect the channel based on the number of downlink consecutive reception error frames counted by the first counter and a communication quality relating to the channel, and
   the wireless communication base station has:
a second counter configured to count a number of uplink consecutive reception error frames relating to the channel; and
a second controller configured to determine whether or not to disconnect the channel based on the number of uplink consecutive reception error frames counted by the second counter and the communication quality relating to the channel.

Furthermore, in the disclosed wireless communication system,
the first controller changes a first disconnect determination threshold based on a communication quality of downlink received frame relating to the channel, and determines to disconnect the channel when the number of downlink consecutive reception error frames relating to the channel is the first disconnect determination threshold or more, and
the second controller changes a second disconnect determination threshold based on a communication quality of uplink received frame relating to the channel, and determines to disconnect the channel when the number of uplink consecutive reception error frames relating to the channel is the second disconnect determination threshold or more.

Moreover, in the disclosed wireless communication system, the first controller changes the first disconnect determination threshold based on the communication quality of downlink received frame relating to the channel and the communication quality of downlink received frame relating to channels other than the channel, and
the second controller changes the second disconnect determination threshold based on the communication quality of uplink received frame relating to the channel and the communication quality of uplink received frame relating to channels other than the channel.

In addition, a disclosed control method of a wireless communication system, in which a wireless communication base station and a wireless communication terminal communicate with each other over one or more wireless signal channels, includes the steps of:
counting, by a first counter relating to the wireless communication terminal, a number of downlink consecutive reception error frames relating to the channel;
determining, by the first controller relating to the wireless communication terminal, whether or not to disconnect the channel based on the number of downlink consecutive reception error frames counted by the first counter and a communication quality relating to the channel;
counting, by a second counter relating to the wireless communication base station, a number of uplink consecutive reception error frames relating to the channel; and
determining, by the second controller relating to the wireless communication base station, whether or not to disconnect the channel based on the number of uplink consecutive reception error frames counted by the second counter and a communication quality relating to the channel.

Furthermore, the disclosed control method of the wireless communication system includes the steps of:
changing, by the first controller, a first disconnect determination threshold based on a communication quality of downlink received frame relating to the channel;
determining, by the first controller, to disconnect the channel when the number of downlink consecutive reception error frames relating to the channel is the first disconnect determination threshold or more, and
changing, by the second controller, a second disconnect determination threshold based on a communication quality of uplink received frame relating to the channel; and
determining, by the second controller, to disconnect the channel when the number of uplink consecutive reception error frames relating to the channel is the second disconnect determination threshold or more.

Moreover, in the disclosed control method of the wireless communication system,
in the step of changing the first disconnect determination threshold,
the first controller changes the first disconnect determination threshold based on the communication quality of downlink received frame relating to the channel and the communication quality of downlink received frame relating to channels other than the channel; and
in the step of changing the second disconnect determination threshold,
the second controller changes the second disconnect determination threshold based on the communication quality of uplink received frame relating to the channel and the communication quality of uplink received frame relating to channels other than the channel.

Furthermore, the disclosed wireless communication terminal has, in a wireless communication terminal of a wireless communication system in which the wireless communication terminal and a wireless communication base station communicate with each other over one or more wireless signal channels,
a first counter configured to count a number of downlink consecutive reception error frames relating to the channel; and
a first controller configured to determine whether or not to disconnect the channel based on the number of downlink consecutive reception error frames counted by the first counter and a communication quality relating to the channel.

Moreover, in the disclosed wireless communication terminal, the first controller changes a first disconnect determination threshold based on a communication quality of downlink received frame relating to the channel, and determines to disconnect the channel when the number of downlink consecutive reception error frames relating to the channel is the first disconnect determination threshold or more.

Furthermore, in the disclosed wireless communication terminal,
the first controller changes the first disconnect determination threshold based on the communication quality of downlink received frame relating to the channel and the communication quality of downlink received frame of channels other than the channel.

Moreover, the disclosed wireless communication base station has, in a wireless communication base station of a wireless communication system in which a wireless communication terminal and the wireless communication base station communicate with each other over one or more wireless signal channels,
a second counter configured to count a number of uplink consecutive reception error frames relating to the channel; and
a second controller configured to determine whether or not to disconnect the channel based on the number of uplink consecutive reception error frames counted by the second counter and a communication quality relating to the channel.

Furthermore, in the disclosed wireless communication base station, the second controller changes a second disconnect determination threshold based on a communication quality of uplink received frame relating to the channel, and disconnects the channel when the number of uplink consecutive reception error frames relating to the channel is the second disconnect determination threshold or more.

Moreover, in the disclosed our wireless communication base station,
the second controller changes the second disconnect determination threshold based on the communication quality of uplink received frame relating to the channel and the communication quality of uplink received frame relating to channels other than the channel.

According to the disclosed wireless communication system, control method of the system, wireless communication terminal and wireless communication base station, decline in communication throughput can be suppressed depending on the wireless environment, whether it be a weak electric field or an intense electric field.

### BRIEF DESCRIPTION OF THE DRAWINGS

In the accompanying drawings:

FIG. 1 is a function block diagram of a wireless communication system according to a disclosed one embodiment;

FIG. 2 is a flowchart diagram illustrating an operation of a wireless communication terminal according to the disclosed one embodiment;

FIG. 3 is a diagram illustrating a channel operation of the wireless communication terminal when consecutive reception error occurs in an intense electric field, according to the disclosed one embodiment;

FIG. 4 is a diagram illustrating a channel reception state of the wireless communication terminal when consecutive reception error occurs in an intense electric field, according to the disclosed one embodiment;

FIG. 5 is a flowchart diagram illustrating an operation of a conventional wireless communication terminal;

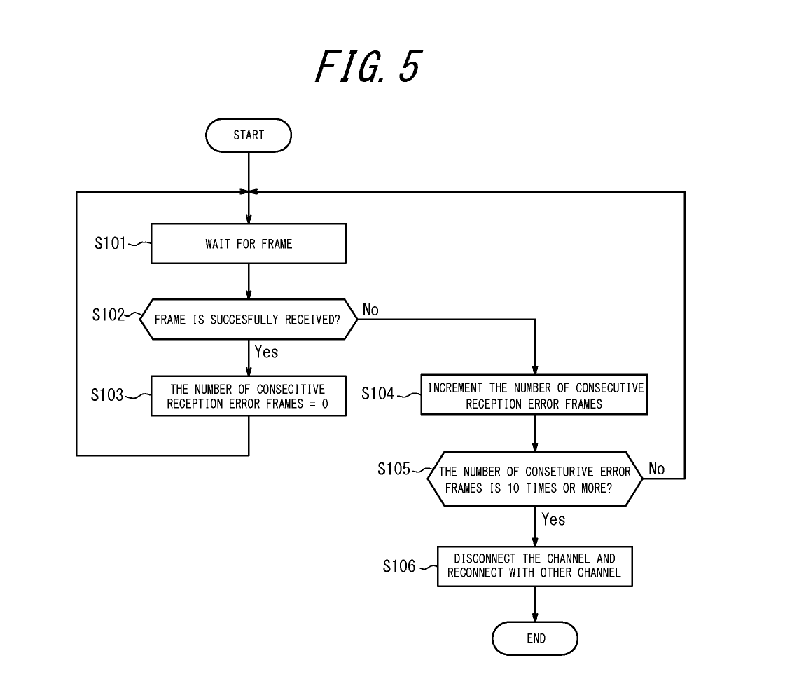

FIG. 6 is a diagram illustrating a channel operation of the conventional communication terminal when consecutive reception error occurs in a weak electric field;

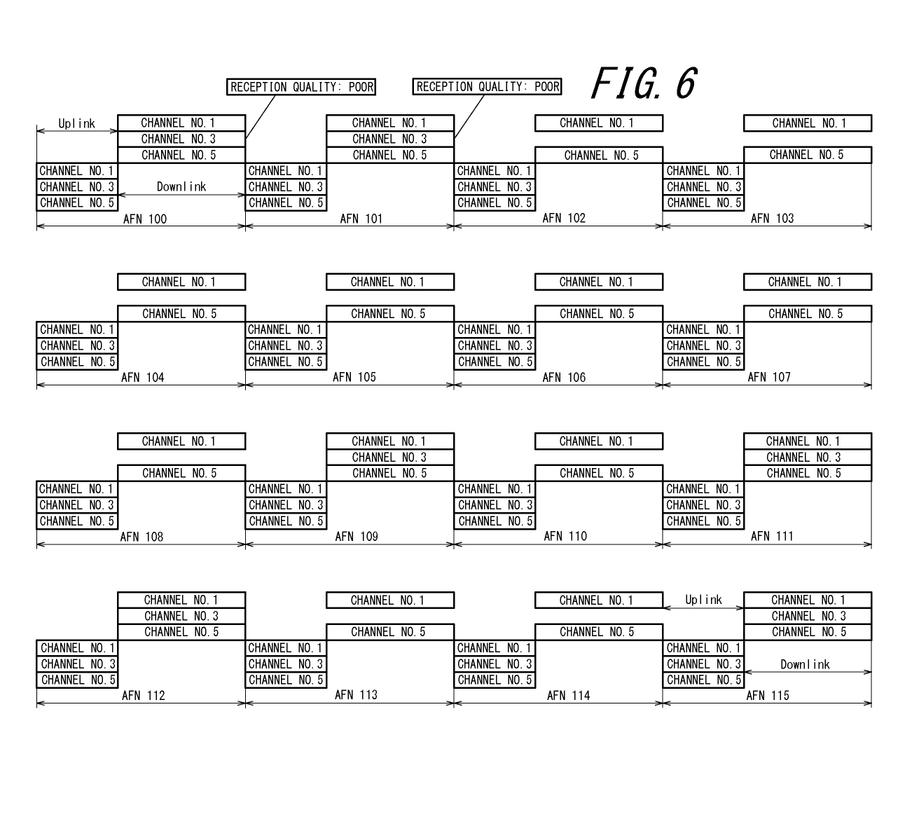

FIG. 7 is a diagram illustrating a channel reception state of the conventional wireless communication terminal when consecutive reception error occurs in a weak electric field;

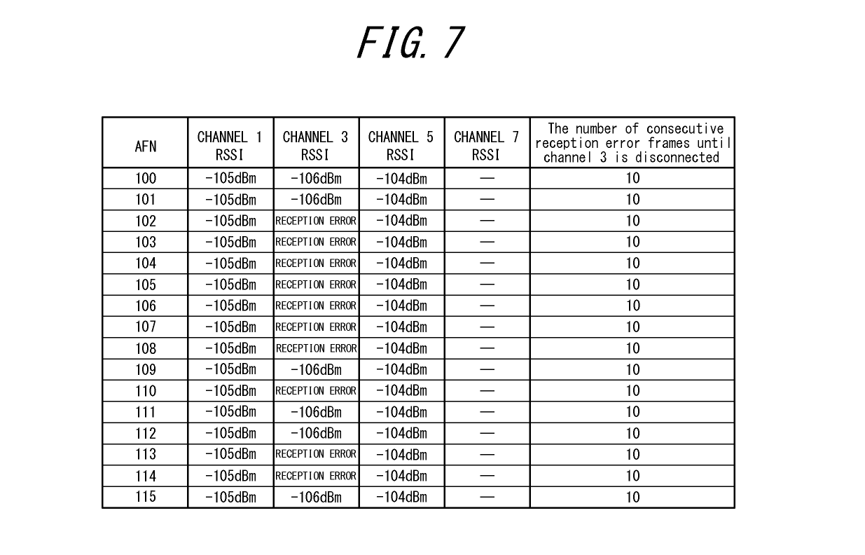

FIG. 8 is a diagram illustrating a channel operation of the conventional wireless communication terminal when consecutive reception error occurs in an intense electric field; and

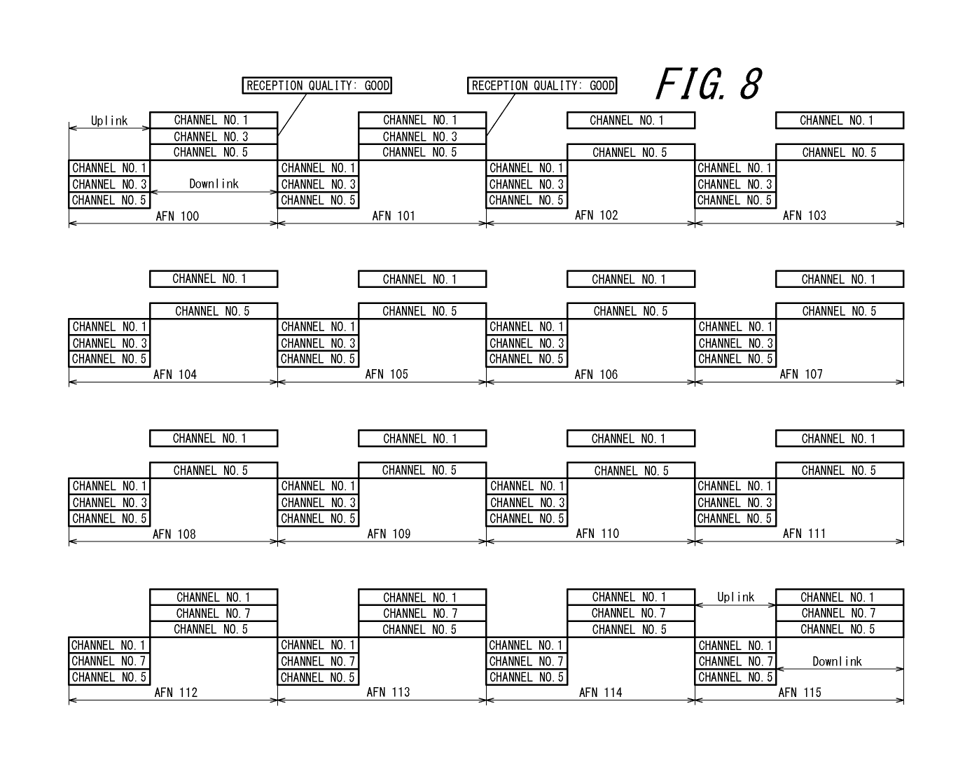

FIG. 9 is a diagram illustrating a channel reception state of the conventional wireless communication terminal when consecutive reception error occurs in an intense electric field.

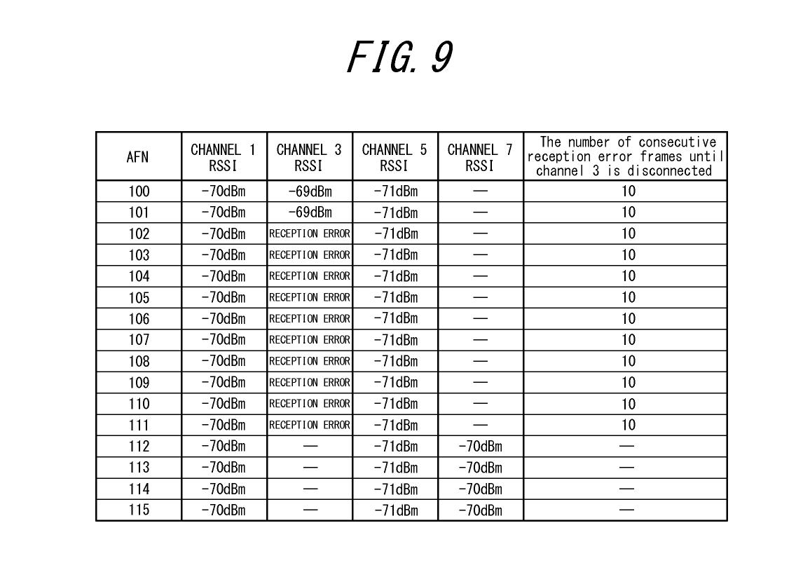

### DETAILED DESCRIPTION

The disclosed one embodiment will be described below with reference to the drawings.

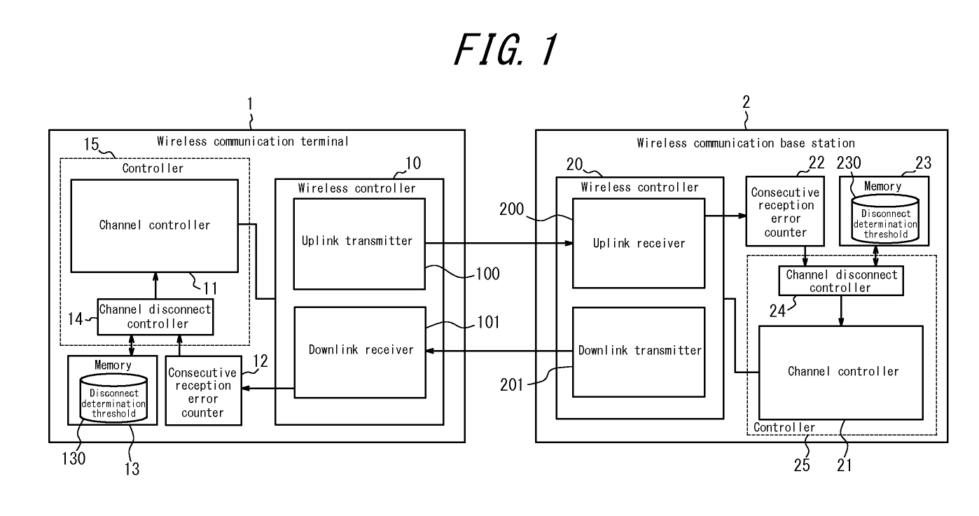

FIG. 1 is a function block diagram of a wireless communication system according to the disclosed one embodiment. It should be noted that

FIG. 1 illustrates only a configuration relating to the problem to be solved by the disclosure. The wireless communication system has a wireless communication terminal 1 and a wireless communication base station 2.

The wireless communication terminal 1 has a wireless controller 10, a consecutive reception error counter 12, a memory 13 and a controller 15 including a channel controller 11 and a channel disconnect controller 14. The wireless communication base station 2 has a wireless controller 20, a consecutive reception error counter 22, a memory 23 and a controller 25 including a channel controller 21 and a channel disconnect controller 24. Each function of the wireless communication base station 2 is the same as that of the wireless communication terminal 1 except that the transmission/reception relationship between the uplink communication and the downlink communication is opposite, thus the explanation thereof is omitted. Furthermore, in the following description, the first and the second counters correspond respectively to the consecutive reception error counters 12 and 22, the first and the second disconnect determination thresholds correspond respectively to disconnect determination thresholds 130 and 230, and the first and the second controllers correspond respectively to controllers 15 and 25.

The wireless controller 10 has an uplink transmitter 100 and a downlink receiver 101. The uplink transmitter 100 performs uplink transmission from the wireless communication terminal 1 to the wireless communication base station 2 by using one or more channels. The downlink receiver 101 performs downlink reception from the wireless communication base station 2 to the wireless communication terminal 1 by using one or more channels. In addition, the downlink receiver 101 determines whether a frame has been successfully received or not. Moreover, the downlink receiver 101 measures a communication quality of received frame relating to each channel used for communication and passes it to the consecutive reception error counter 12. Although the communication quality is described as RSSI (Received Signal Strength Indicator) below, it may be DSSI (Desired Signal Strength Indicator), SINR (Signal to Interference and Noise power Ratio) or FER (Frame Error Rate), or the like.

The channel controller 11 connects and disconnects channels used for transmission and reception. Specifically, when the channel controller 11 receives a channel disconnect command from the channel disconnect controller 14, it disconnects a channel relating to the disconnect command and reconnects with other unused channel.

The consecutive reception error counter 12 passes the communication quality obtained from the downlink receiver 101 to the channel disconnect controller 14. In addition, the consecutive reception error counter 12 counts the number of consecutive reception error frames with respect to each channel used for communication and passes the number to the channel disconnect controller 14. Specifically, when the frame has been successfully received with respect to the channel used for communication, the consecutive reception error counter 12 sets the number of consecutive reception error frames to zero. On the other hand, when the frame has not been successfully received, that is, when a reception error frame has occurred, the consecutive reception error counter 12 increments the number of consecutive reception error frames.

The memory 13 stores a disconnect determination threshold 130 described later. In addition, the memory 13 updates the disconnect determination threshold 130 and stores it under control of the channel disconnect controller 14.

The channel disconnect controller 14 obtains a communication quality of received frame or the number of consecutive reception error frames relating to each channel from the consecutive reception error counter 12. In addition, the channel disconnect controller 14 determines whether the obtained communication quality is a predetermined threshold (hereinafter referred to as a reception strength threshold) or more or not, and recalculates the disconnect determination threshold 130. Specifically, when the communication quality of received frame is the reception strength threshold or more, the channel disconnect controller 14 changes the disconnect determination threshold 130 to a smaller value (e.g. 5 times) and stores it in the memory 13. On the other hand, when the communication quality of received frame is less than the reception strength threshold, the channel disconnect controller 14 changes the disconnect determination threshold 130 to a larger value (e.g. 10 times as in the case of the prior art) and stores it in the memory 13. In this manner, when the communication quality of received frame is the reception strength threshold or more, the channel disconnect controller 14 determines it as an intense electric field and decreases the number of frames required until channel disconnection is determined. On the contrary, when the communication quality of received frame is less than the reception strength threshold, the channel disconnect controller 14 determines it as a weak electric field and increases the number of frames required until channel disconnection is determined. Here, although the reception strength threshold is −75 dBm, for example, any value can be adopted.

In this embodiment, an obtained communication quality is compared with a reception strength threshold. However, for example, the channel disconnect controller 14 may store the obtained communication quality in the memory 13, and compare the average value of communication quality relating to a plurality of received frames with the reception strength threshold. In addition, for example, the disconnect determination threshold 130 may be recalculated based on the communication quality including other channels used for communication and the reception strength threshold. Specifically, the average value of the communication quality of received frame relating to all channels used for communication may be compared with the reception strength threshold. Thus, accuracy in determining whether the wireless environment is a weak electric field or an intense electric field can be improved.

Moreover, the channel disconnect controller 14 determines whether the number of consecutive reception error frames obtained from the consecutive reception error counter 12 is the disconnect determination threshold 130 or not and decides whether or not to disconnect the channel. Specifically, when the number of consecutive reception error frames is the disconnect determination threshold 130 or more, the channel disconnect controller 14 gives a command of disconnecting a channel relating to the reception error to the channel controller 11.

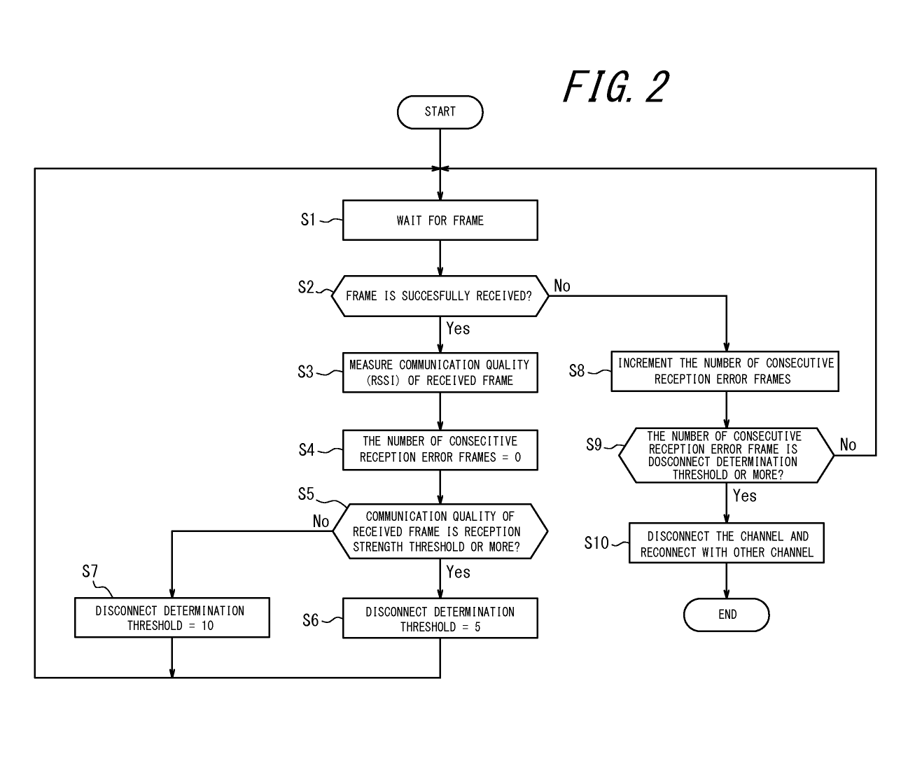

FIG. 2 is a flowchart diagram illustrating an operation of the wireless communication terminal 1 according to the disclosed one embodiment. FIG. 2 illustrates an operation to one channel among a plurality of channels for communication with the wireless communication base station 2. First, the wireless communication terminal 1 waits for receiving a frame relating to a downlink communication (step S1). Then, the downlink receiver 101 determines whether the frame has been successfully received or not (step S2).

In step S2, when the frame has been successfully received, the downlink receiver 101 measures the communication quality of received frame relating to the channel used for communication (step S3).

Subsequently the consecutive reception error counter 12 sets the number of consecutive reception error frames to zero (step S4).

Subsequently the channel disconnect controller 14 determines whether or not the communication quality of received frame is the reception strength threshold or more (step S5).

In step S5, when the communication quality is the reception strength threshold or more, the channel disconnect controller 14 changes the disconnect determination threshold 130 to a smaller value (e.g. 5 times) and stores it in the memory 13 (step S6), and the process returns to step S1. On the other hand, in step S5, when the communication quality is less than the reception strength threshold, the channel disconnect controller 14 changes the disconnect determination threshold 130 to a larger value (e.g. 10 times) and stores it in the memory 13 (step S7), and the process returns to step S1.

On the other hand, in step S2, when the frame has not been successfully received, the consecutive reception error counter 12 increments the number of consecutive reception error frames (step S8).

Subsequently the channel disconnect controller 14 determines whether or not the number of consecutive reception error frames obtained from the consecutive reception error counter 12 is the disconnect determination threshold 130 or more (step S9).

In step S9, when the number of consecutive reception error frames is the disconnect determination threshold 130 or more, the channel controller 11 disconnects the channel relating to a channel disconnection command when it receives the channel disconnect command from the channel disconnect controller 14, and reconnects with the other unused channel (step S10), then the process is terminated.

On the other hand, in step S9, when the number of consecutive reception error frames is less than the disconnect determination threshold 130, the process returns to step S1.

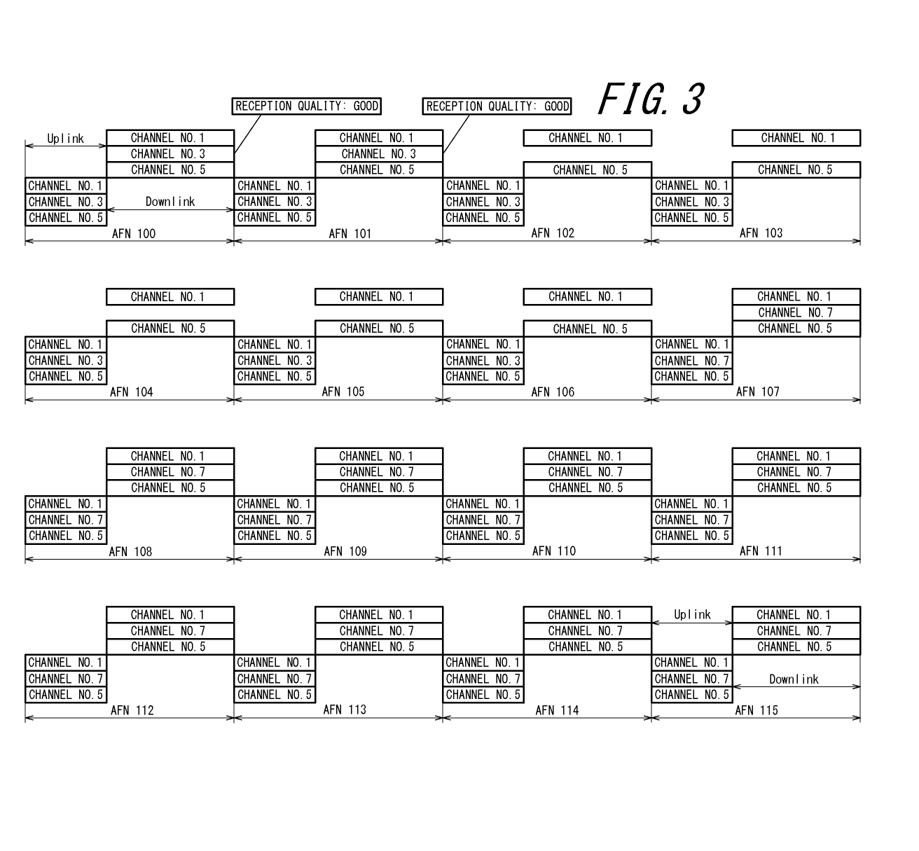

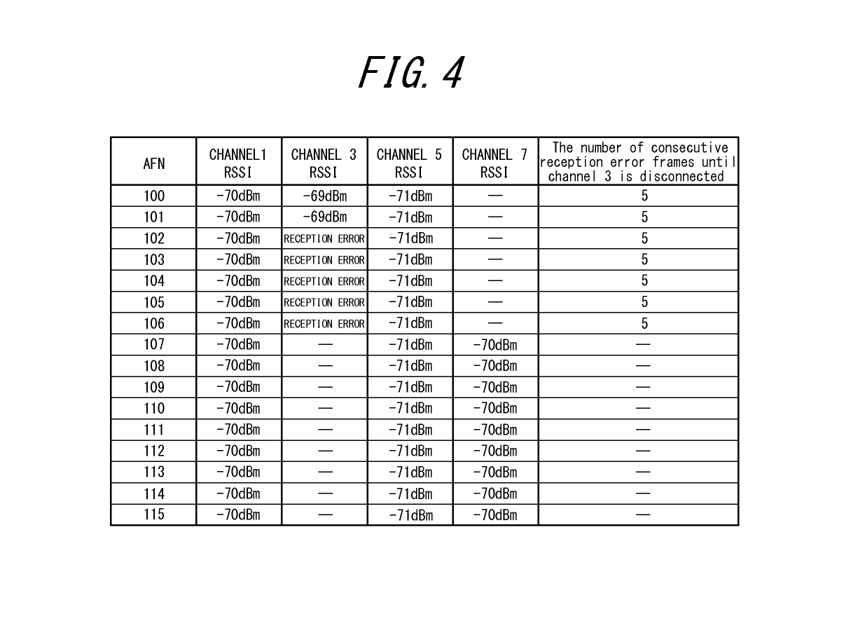

An operation of the wireless communication terminal 1 according to the disclosed one embodiment when consecutive reception error occurs in an intense electric field will be described more specifically with reference to FIGS. 3 and 4. FIG. 3 is a diagram illustrating a channel operation of the wireless communication terminal 1 according to the disclosed one embodiment when consecutive reception error occurs in an intense electric field. FIG. 4 is a diagram illustrating a channel reception state of the wireless communication terminal 1 according to the disclosed one embodiment when consecutive reception error occurs in an intense electric field. In FIGS. 3 and 4, the wireless communication terminal 1 communicates with the wireless communication base station 2 using three channels (channels 1, 3 and 5). In addition, in FIGS. 3 and 4, 16 frames in total from AFNs 100 to 115 are illustrated.

First, in AFNs 100 and 101, the downlink reception quality relating to channel 3 is −69 dBm. When the reception strength threshold is −75 dBm, the reception quality is good, thus determined as an intense electric field. Thus, the channel disconnect controller 14 changes the disconnect determination threshold 130 to 5 times.

Next, in AFNs 102 to 106, a reception error frame occurs 5 times in a row in the channel 3. During this, communication is performed by using 2 channels, thus the communication throughput is declined. Here, in AFN 106, since the number of consecutive reception error frames is the disconnect determination threshold 130 or more, the channel disconnect controller 14 gives a command to the channel controller 11 to disconnect the channel 3. The channel controller 11 disconnects the channel 3 and reconnects with the unused channel 7.

Then, in AFNs 107 to 115, the wireless communication terminal 1 communicates by using three channels (channels 1, 5 and 7), thus communication throughput is maintained. Due to an intense electric field, the reception quality relating to the channel 7 is better than the reception strength threshold (−75 dBm) when comparing between them. Thus, reconnection with the channel 7 is made easily.

Therefore, when a reception error occurs suddenly in a row in an intense electric field, the frames with declined communication throughput are five frames from AFNs 102 to 106 (for 25 msec). Compared with the prior art, the period of time during which the communication throughput declines is half (10 frames, for 50 msec).

Thus, the disclosed one embodiment allows suppression of an unnecessary channel disconnect in a weak electric field and, when a communication error occurs in an intense electric field, immediate switching to other unused channels as well. That is, compared with the case where the threshold of the number of consecutive reception error frames until channel is disconnected is fixed, as in the case of prior art, a constant communication throughput is maintained in a weak electric field and communication throughput is improved in an intense electric field. Therefore, decline in the communication throughput can be suppressed depending on the wireless environment, whether a weak electric field or an intense electric field.

Furthermore, the disclosed one embodiment is applicable to both TDD (Time Division Duplex) and FDD (Frequency Division Duplex) wireless communication systems.

It should be noted that, in the above described one embodiment, one reception strength threshold (−75 dBm) is used to determine whether a weak electric field or an intense electric field. However, two or more reception strength thresholds may be provided for determination of the strength of electric field. In this case, change is made such that, the higher the electric field strength is, the smaller the disconnect determination threshold 130 is. For example, when the first reception strength threshold is −75 dBm and the second reception strength threshold is −90 dBm, when the communication quality relating to a reception frame is the first reception strength threshold or more, this is regarded as an intense electric field, and the disconnect determination threshold 130 is changed to 5 times. Moreover, when the communication quality is the second reception strength threshold or more and less than the first reception strength threshold, this is regarded as a middle electric field, and the disconnect determination threshold 130 is changed to 7 times. Then, when the communication quality is less than the second reception strength, this is regarded as a weak electric field, and the disconnect determination threshold 130 may be changed to 10 times.

Although the disclosure has been described based on accompanying drawings, it should be noted that various changes and modifications will be apparent to a person skilled in the art. For example, the functions or the like included in the means, steps, or the like, may be reordered in any logically consistent way. Furthermore, means, steps or the like may be combined into one or divided.

### REFERENCE SIGNS LIST

1 Wireless communication terminal

10 Wireless controller

100 Uplink transmitter

101 Downlink receiver

11 Channel controller

12 Consecutive reception error counter

13 Memory

130 Disconnect determination threshold

14 Channel disconnect controller

15 Controller

2 Wireless communication base station

20 Wireless controller

200 Uplink receiver

201 Downlink transmitter

21 Channel controller

22 Consecutive reception error counter

23 Memory

230 Disconnect determination threshold

24 Channel disconnect controller

25 Controller

1. A wireless communication system in which a wireless communication terminal and a wireless communication base station communicate with each other over one or more wireless signal channels, wherein
the wireless communication terminal comprising:
a first counter configured to count a number of downlink consecutive reception error frames relating to the channel; and
a first controller configured to determine whether or not to disconnect the channel based on the number of downlink consecutive reception error frames counted by the first counter and a communication quality relating to the channel, and
the wireless communication base station comprising:
a second counter configured to count a number of uplink consecutive reception error frames relating to the channel: and
a second controller configured to determine whether or not to disconnect the channel based on the number of uplink consecutive reception error frames counted by the second counter and the communication quality relating to the channel.

2. The wireless communication system according to claim 1, wherein
the first controller changes a first disconnect determination threshold based on a communication quality of downlink received frame relating to the channel, and determines, when the number of downlink consecutive reception error frames relating to the channel is the first disconnect determination threshold or more, to disconnect the channel, and
the second controller changes a second disconnect determination threshold based on a communication quality of uplink received frame relating to the channel, and determines, when the number of uplink consecutive reception error frames relating to the channel is the second disconnect determination threshold or more, to disconnect the channel.

3. The wireless communication system according to claim 2, wherein
the first controller changes the first disconnect determination threshold based on the communication quality of downlink received frame relating to the channel and the communication quality of downlink received frame relating to channels other than the channel, and
the second controller changes the second disconnect determination threshold based on the communication quality of uplink received frame relating to the channel and the communication quality of uplink received frame relating to channels other than the channel.

4. A control method of a wireless communication system in which a wireless communication base station and a wireless communication terminal communicate with teach other over one or more wireless signal channels, comprising the steps of:
counting, by a first counter relating to the wireless communication terminal, a number of downlink consecutive reception error frames relating to the channel;
determining, by the first controller relating to the wireless communication terminal, whether or not to disconnect the channel based on the number of downlink consecutive reception error frames counted by the first counter and a communication quality relating to the channel;
counting, by a second counter relating to the wireless communication base station, a number of uplink consecutive reception error frames relating to the channel; and
determining, by the second controller relating to the wireless communication base station, whether or not to disconnect the channel based on the number of uplink consecutive reception error frames counted by the second counter and the communication quality relating to the channel.

5. The control method of the wireless communication system according to claim 4, comprising the steps of:
changing, by the first controller, a first disconnect determination threshold based on a communication quality of downlink received frame relating to the channel;
determining, by the first controller, to disconnect the channel when the number of downlink consecutive reception error frames relating to the channel is the first disconnect determination threshold or more;
changing, by the second controller, a second disconnect determination threshold based on a communication quality of uplink received frame relating to the channel; and
determining, by the second controller, to disconnect the channel when the number of uplink consecutive reception error frames relating to the channel is the second disconnect determination threshold or more.

6. The control method of the wireless communication system according to claim 5, wherein,
in the step of changing the first disconnect determination threshold, the first controller changes the first disconnect determination threshold based on the communication quality of downlink received frame relating to the channel and the communication quality of downlink received frame relating to channels other than the channel; and
in the step of changing the second disconnect determination threshold, the second controller changes the second disconnect determination threshold based on the communication quality of uplink received frame relating to the channel and the communication quality of uplink received frame relating to channels other than the channel.

7. A wireless communication terminal in a wireless communication system in which the wireless communication terminal and a wireless communication base station communicate with each other over one or more wireless signal channels, comprising:
a first counter configured to count a number of downlink consecutive reception error frames relating to the channel; and
a first controller configured to determine whether or not to disconnect the channel based on the number of downlink consecutive reception error frames counted by the first counter and a communication quality relating to the channel.

8. The wireless communication terminal according to claim 7, wherein
the first controller changes a first disconnect determination threshold based on a communication quality of downlink received frame relating to the channel, and determines to disconnect the channel when the number of downlink consecutive reception error frames relating to the channel is the first disconnect determination threshold or more.

9. The wireless communication terminal according to claim 8, wherein
the first controller changes the first disconnect determination threshold based on the communication quality of downlink received frame relating to the channel and the communication quality of downlink received frame relating to channels other than the channel.

10. A wireless communication base station in a wireless communication system in which a wireless communication terminal and the wireless communication base station communicate with each other over one or more wireless signal channels, comprising:
a second counter configured to count a number of uplink consecutive reception error frames relating to the channel; and
a second controller configured to determine whether or not to disconnect the channel based on the number of uplink consecutive reception error frames counted by the second counter and a communication quality relating to the channel.

11. The wireless communication base station according to claim 10, wherein
the second controller changes a second disconnect determination threshold based on a communication quality of uplink received frame relating to the channel, and determines to disconnect the channel when the number of uplink consecutive reception error frames relating to the channel is the second disconnect determination threshold or more.

12. The wireless communication base station according to claim 11, wherein the second controller changes the second disconnect determination threshold based on the communication quality of uplink received frame relating to the channel and the communication quality of uplink received frame relating to channels other than the channel.
